(19) United States
(12) Patent Application Publication
(10) Pub. No.: US 2026/0012424 A1
(43) Pub. Date: Jan. 8, 2026

(54) METHODS AND APPARATUSES FOR NETWORK TRAFFIC CONTROL

(71) Applicant: Telefonaktiebolaget LM Ericsson (publ), Stockholm (SE)

(72) Inventor: Chao Xu, Shanghai (CN)

(21) Appl. No.: 18/992,597

(22) PCT Filed: Jul. 12, 2022
(86) PCT No.: PCT/CN2022/105296

§ 371 Date: Jan. 9, 2025

(51) Int. Cl. H04L 47/24; H04L 41/0816

(52) U.S. Cl. CPC H04L 47/24; H04L 41/0816

(57) ABSTRACT

Methods and apparatuses for network traffic control are disclosed. According to an embodiment, a first network function (NF) receives, from a second NF, control information for controlling non-access stratum (NAS) traffic that is to be processed by the first NF. The control information instructs the first NF to perform a predetermined action on the NAS traffic when the NAS traffic satisfies a predetermined condition. The first NF sends, to the second NF, a response to the control information.

### TECHNICAL FIELD

Embodiments of the disclosure generally relate to communication, and, more particularly, to methods and apparatuses for network traffic control.

### BACKGROUND

This section introduces aspects that may facilitate better understanding of the present disclosure. Accordingly, the statements of this section are to be read in this light and are not to be understood as admissions about what is in the prior art or what is not in the prior art.

In communications, traffic control is the process of managing, controlling, and reducing network traffic. Well defined traffic control policy not only helps customer to gain better network performance, but also enhances the network security by dropping abnormal traffic. Currently, the 5th generation core (5GC) provides below features related to traffic control: network access control, policy control, and rate control of data over non-access stratum (NAS).

With the network access control, only authenticated users are allowed to connect to the 5th generation (5G) core network (CN). Depending on network configuration, the network may determine whether certain access attempt should be allowed or blocked based on categorized criteria like slices, location, user type, etc. In some cases, it also allows the network to reject or ignore users' access when network overload happens.

With the policy control, when users are connected to the 5G CN, policy control function (PCF) could apply different policies to enable finer granularity of traffic control in the network. The control may include, but not limited to, session management policy control, traffic steering control, monitoring control, etc.

The rate control of data over NAS is a special use case for e.g. user equipment (UE) using cellular Internet of things (CIoT) 5G system (5GS) optimization. When the payload is transported via control plane instead of user plane, control plane network function (NF) like access and mobility management function (AMF) could offer services such as “maximum of Y messages per day” to limit one UE's traffic.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide an improved solution for network traffic control. In particular, one of the problems to be solved by the disclosure is that the existing solution for network traffic control is inefficient in some cases. Another problem to be solved by the disclosure is that the existing solution for network traffic control lacks flexible content-based traffic control in control plane.

According to a first aspect of the disclosure, there is provided a method performed by a first network function (NF). The method may comprise receiving, from a second NF, control information for controlling non-access stratum (NAS) traffic that is to be processed by the first NF. The control information may instruct the first NF to perform a predetermined action on the NAS traffic when the NAS traffic satisfies a predetermined condition. The method may further comprise sending, to the second NF, a response to the control information.

In this way, it is possible to configure control information for NAS traffic.

In an embodiment of the disclosure, the method may further comprise, when the NAS traffic satisfies the predetermined condition, performing the predetermined action on the NAS traffic according to the control information.

In an embodiment of the disclosure, the method may further comprise sending, to the second NF, assistance information usable for determining the control information.

In an embodiment of the disclosure, the assistance information may comprise one or more of: at least one key performance indicator (KPI) related to the NAS traffic; at least one counter for checking health status of the first network function; a log of events occurring at the first network function; and the NAS traffic processed by the first network function.

In an embodiment of the disclosure, the predetermined action may be one of: accepting the NAS traffic; rejecting the NAS traffic; and ignoring the NAS traffic.

In an embodiment of the disclosure, the control information may comprise: a first identifier (ID) identifying a target NF for which the control is applied to the NAS traffic; a first indicator indicating at least one rule for defining the predetermined condition; and a second indicator indicating the predetermined action.

In an embodiment of the disclosure, the control information may further comprise one or more of: a second ID identifying the control information; and a third indicator indicating a validity time of the control information.

In an embodiment of the disclosure, the at least one rule comprises one or more of: a first rule indicating that the control should be applied to the NAS traffic of any terminal device; a second rule indicating that the control should be applied to the NAS traffic of a specific terminal device; a third rule indicating that the control should be applied in one or more specific events; a fourth rule indicating that the control should be applied to the NAS traffic related to a specific data network name (DNN); a fifth rule indicating that the control should be applied to the NAS traffic related to a specific protocol data unit (PDU) session; a sixth rule indicating that the control should be applied to the NAS traffic of one or more terminal devices at a specific location; and a seventh rule indicating that the control should be applied to the NAS traffic having a specific traffic pattern.

In an embodiment of the disclosure, the NAS traffic having the specific traffic pattern may be an NAS traffic whose payload is an Internet protocol (IP) based packet having a specific feature in content.

In an embodiment of the disclosure, the IP based packet may comprise one or more of: an Internet control message protocol (ICMP) packet; a transmission control protocol (TCP) packet; a user datagram protocol (UDP) packet; and a stream control transmission protocol (SCTP) packet.

In an embodiment of the disclosure, the response may indicate that the control applied to the NAS traffic is initiated. Or the response may indicate why the control applied to the NAS traffic cannot be initiated.

In an embodiment of the disclosure, the first NF may be one of: an access and mobility management function (AMF); a session management function (SMF); a network exposure function (NEF); and a short message service function (SMSF).

In an embodiment of the disclosure, the second NF may be one of: a network data analytics function (NWDAF); and an operation and maintenance (O&M).

In an embodiment of the disclosure, the target NF may be one of: an SMF; an NEF; a unified data management (UDM); a policy control function (PCF); and an application function (AF).

According to a second aspect of the disclosure, there is provided a method performed by a second NF. The method may comprise sending, to a first NF, control information for controlling NAS traffic that is to be processed by the first NF. The control information may instruct the first NF to perform a predetermined action on the NAS traffic when the NAS traffic satisfies a predetermined condition. The method may further comprise receiving, from the first NF, a response to the control information.

In this way, it is possible to configure control information for NAS traffic.

In an embodiment of the disclosure, the method may further comprise receiving, from the first NF or another NF related to the first NF, assistance information usable for determining the control information. The method may further comprise determining the control information based on the assistance information.

In an embodiment of the disclosure, the assistance information may comprise one or more of: at least one KPI related to the NAS traffic; at least one counter for checking health status of the first network function; a log of events occurring at the first network function; and the NAS traffic processed by the first network function.

In an embodiment of the disclosure, the predetermined action may be one of: accepting the NAS traffic; rejecting the NAS traffic; and ignoring the NAS traffic.

In an embodiment of the disclosure, the control information may comprise: a first ID identifying a target NF for which the control is applied to the NAS traffic; a first indicator indicating at least one rule for defining the predetermined condition; and a second indicator indicating the predetermined action.

In an embodiment of the disclosure, the control information may further comprise one or more of: a second ID identifying the control information; and a third indicator indicating a validity time of the control information.

In an embodiment of the disclosure, the at least one rule may comprise one or more of: a first rule indicating that the control should be applied to the NAS traffic of any terminal device; a second rule indicating that the control should be applied to the NAS traffic of a specific terminal device; a third rule indicating that the control should be applied in one or more specific events; a fourth rule indicating that the control should be applied to the NAS traffic related to a specific DNN; a fifth rule indicating that the control should be applied to the NAS traffic related to a specific PDU session; a sixth rule indicating that the control should be applied to the NAS traffic of one or more terminal devices at a specific location; and a seventh rule indicating that the control should be applied to the NAS traffic having a specific traffic pattern.

In an embodiment of the disclosure, the NAS traffic having the specific traffic pattern may be an NAS traffic whose payload is an IP based packet having a specific feature in content.

In an embodiment of the disclosure, the IP based packet may comprise one or more of: an ICMP packet; a TCP packet; a UDP packet; and an SCTP packet.

In an embodiment of the disclosure, the response may indicate that the control applied to the NAS traffic is initiated. Or the response may indicate why the control applied to the NAS traffic cannot be initiated.

In an embodiment of the disclosure, the first NF may be one of: an AMF; an SMF; an NEF; and an SMSF.

In an embodiment of the disclosure, the second NF may be one of: an NWDAF; and an O&M.

In an embodiment of the disclosure, the target NF may be one of: an SMF; an NEF; a UDM; a PCF; and an AF.

According to a third aspect of the disclosure, there is provided an apparatus implementing a first NF. The apparatus may comprise at least one processor and at least one memory. The at least one memory may contain instructions executable by the at least one processor, whereby the apparatus may be operative to receive, from a second NF, control information for controlling NAS traffic that is to be processed by the first NF. The control information may instruct the first NF to perform a predetermined action on the NAS traffic when the NAS traffic satisfies a predetermined condition. The apparatus may be further operative to send, to the second NF, a response to the control information.

In an embodiment of the disclosure, the apparatus may be operative to perform the method according to the above first aspect.

According to a fourth aspect of the disclosure, there is provided an apparatus implementing a second NF. The apparatus may comprise at least one processor and at least one memory. The at least one memory may contain instructions executable by the at least one processor, whereby the apparatus may be operative to send, to a first NF, control information for controlling NAS traffic that is to be processed by the first NF. The control information may instruct the first NF to perform a predetermined action on the NAS traffic when the NAS traffic satisfies a predetermined condition. The apparatus may be further operative to receive, from the first NF, a response to the control information.

In an embodiment of the disclosure, the apparatus may be operative to perform the method according to the above second aspect.

According to a fifth aspect of the disclosure, there is provided a computer program product. The computer program product may comprise instructions which when executed by at least one processor, cause the at least one processor to perform the method according to any of the above first and second aspects.

According to a sixth aspect of the disclosure, there is provided a computer readable storage medium. The computer readable storage medium may store thereon instructions which when executed by at least one processor, cause the at least one processor to perform the method according to any of the above first and second aspects.

According to a seventh aspect of the disclosure, there is provided an apparatus implementing a first NF. The apparatus may comprise a reception module for receiving, from a second NF, control information for controlling NAS traffic that is to be processed by the first NF. The control information may instruct the first NF to perform a predetermined action on the NAS traffic when the NAS traffic satisfies a predetermined condition. The apparatus may further comprise a sending module for sending, to the second NF, a response to the control information.

According to an eighth aspect of the disclosure, there is provided an apparatus implementing a second NF. The apparatus may comprise a sending module for sending, to a first NF, control information for controlling NAS traffic that is to be processed by the first NF. The control information may instruct the first NF to perform a predetermined action on the NAS traffic when the NAS traffic satisfies a predetermined condition. The apparatus may further comprise a reception module for receiving, from the first NF, a response to the control information.

According to a ninth aspect of the disclosure, there is provided a method implemented in a communication system including a first NF and a second NF. The method may comprise steps of the methods according to the above first and second aspects.

According to a tenth aspect of the disclosure, there is provided a communication system including an apparatus implementing a first NF according to the above third or seventh aspect and an apparatus implementing a second NF according to the above fourth or eighth aspect.

Based on the above description, the present disclosure allows NF to support NAS traffic control to expose its ability to other NF. In this way, it is possible to do dynamic traffic control based on real-time traffic. Particular example is to throttle unexpected network burst. The present disclosure also proposes the control information structure describing the NAS traffic in different dimension which guarantees finer granular control. Besides the traditional rate control, it could perform NF or UE level traffic control, or even content-based NAS traffic control.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 is a diagram illustrating an exemplary communication system into which an embodiment of the disclosure is applicable;

FIG. 2 is a flowchart illustrating a method performed by a first network function according to an embodiment of the disclosure;

FIG. 3 is a flowchart illustrating a method performed by a first network function according to an embodiment of the disclosure;

FIG. 4 is a flowchart illustrating a method performed by a second network function according to an embodiment of the disclosure;

FIG. 5 is a flowchart illustrating a method performed by a second network function according to an embodiment of the disclosure;

FIG. 6 is a diagram illustrating an exemplary embodiment of the disclosure;

FIG. 7 is a flowchart illustrating an exemplary process according to an embodiment of the disclosure;

FIG. 8 is a diagram illustrating an AMF according to an embodiment of the disclosure;

FIG. 9 is a flowchart illustrating an exemplary process according to an embodiment of the disclosure;

FIG. 10 is a diagram illustrating an exemplary process according to an embodiment of the disclosure;

FIG. 11 is a diagram illustrating a detection result obtained according to an embodiment of the disclosure;

FIG. 12 is a diagram illustrating the effect obtained according to an embodiment of the disclosure;

FIG. 13 is a diagram illustrating the behavior of the existing solution in the scenario of DDOS attack;

FIG. 14 is a diagram illustrating the behavior of an embodiment of the disclosure in the scenario of DDOS attack;

FIG. 15 is a block diagram showing an apparatus suitable for use in practicing some embodiments of the disclosure;

FIG. 16 is a block diagram showing an apparatus implementing a first network function according to an embodiment of the disclosure;

FIG. 17 is a block diagram showing an apparatus implementing a second network function according to an embodiment of the disclosure;

FIG. 18 is diagram illustrating an example of a communication system in accordance with some embodiments;

FIG. 19 is a diagram illustrating a UE in accordance with some embodiments;

FIG. 20 is a diagram illustrating a network node in accordance with some embodiments;

FIG. 21 is a diagram illustrating a host in accordance with some embodiments;

FIG. 22 is a diagram illustrating a virtualization environment in which functions implemented by some embodiments may be virtualized; and

FIG. 23 is a diagram illustrating a host communicating via a network node with a UE over a partially wireless connection in accordance with some embodiments.

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

The existing solution for traffic control in 5GC has below issues. The first issue is inefficiency in traffic control. This is due to the limitation of 5GC architecture. In 5GC, network functionalities are now separated into different NFs. Each NF manages its own traffic policy. There is no coordination between different NFs. Considering the scenario when session management function (SMF) or network data analytics function (NWDAF) identified certain abnormal session establishment requests from one UE and planned to throttle it. Currently, it is not hard for SMF to ignore the abnormal traffic locally. However, from the perspective of the core network, the more efficient way is to inform AMF to discard the traffic at the frontend. But unfortunately, as AMF is only responsible for handling connection and mobility management tasks, AMF still have to relay the abnormal session messages to SMF. It is a waste of network resources.

The second issue is lack of flexible content-based traffic control in control plane. Existing traffic control solutions are rule based and rules are normally statically configured. Normally, there is not much policy for controlling traffic carried by control plane. Considering if one Internet of things (IoT) device is infected with malicious application and the NF wants to ignore the dedicated traffic pattern from the IoT device. The existing solutions like rate control or access control will ignore all packages originating from the device indiscriminately. There is no framework to allow the NF to perform content-based traffic control like only throttling the abnormal traffic flow if some certain pattern matches.

The present disclosure proposes an improved solution for network traffic control. The basic idea is to introduce a new ‘NAS Traffic Control’ service in an NF such as AMF. Take the AMF as an example. With the new ‘NAS Traffic Control’ service, the AMF allows other NFs (e.g. SMF, NEF, NWDAF, etc.) to set TrafficControlInformation on the AMF (or an O&M sets it on the AMF directly). The TrafficControlInformation may contain targets, rules, actions and optionally other supplementary IEs which the AMF could interpret and apply to the network traffic. When the traffic flow or package matches certain rule, the AMF takes corresponding action like accept, reject, or ignore the matched traffic.

The rule of the ‘NAS Traffic Control’ service may be implementation dependent. Besides the information like subscription permanent identifier (SUPI), location, DNN which are commonly used in existing solution, it also allows other NF to give certain traffic pattern (e.g. linux iptables U32 extension alike pattern) which allows the AMF to filter upper layer traffic (e.g. data over NAS (e.g. SMS)) without understanding the whole content of the package. Theoretically, the pattern is flexible enough to let the AMF do traffic control for all possible traffic through it. This can turn the AMF into a frontend firewall in the 5GC. Note that the new service defined above is common and could be provided by an NF other than AMF depending on use cases.

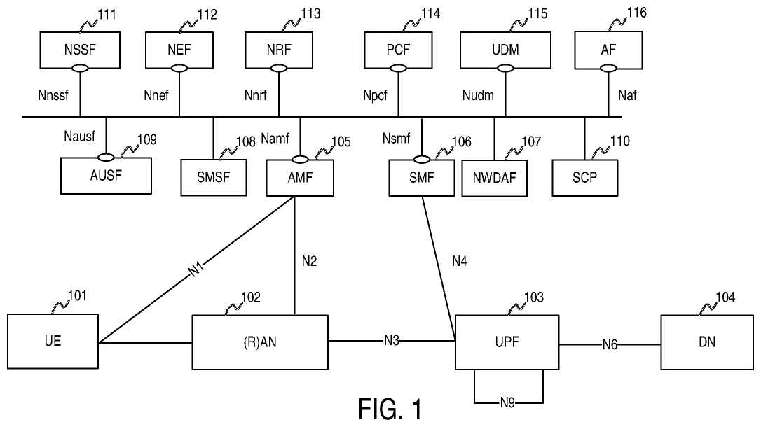

Hereinafter, the solution will be described in detail with reference to FIGS. 1-17. FIG. 1 is a diagram illustrating an exemplary communication system into which an embodiment of the disclosure is applicable. As shown, the communication system comprises a user equipment (UE) 101, a (radio) access network ((R)AN) 102, a user plane function (UPF) 103, a data network (DN) 104, an access and mobility management function (AMF) 105, a session management function (SMF) 106, a network data analytics function (NWDAF) 107, a short message service function (SMSF) 108, an authentication server function (AUSF) 109, a service communication proxy (SCP) 110, a network slice selection function (NSSF) 111, a network exposure function (NEF) 112, a network repository function (NRF) 113, a policy control function (PCF) 114, a unified data management (UDM) 115 and an application function (AF) 116. The functional description of the above entities can be found from clause 6 of 3GPP TS 23.501 V17.1.1. Note that although not shown in the FIG. 1, the communication system may further comprise an operation and maintenance (O&M) or operation, administration and maintenance (OAM).

Within the context of this disclosure, the term UE or terminal device may also be referred to as, for example, device, access terminal, mobile station, mobile unit, subscriber station, or the like. It may refer to any end device that can access a wireless communication network and receive services therefrom. By way of example and not limitation, the UE or terminal device may include a portable computer, an image capture terminal device such as a digital camera, a gaming terminal device, a music storage and playback appliance, a mobile phone, a cellular phone, a smart phone, a tablet, a wearable device, a personal digital assistant (PDA), or the like.

In an Internet of things (IoT) scenario, a UE or terminal device may represent a machine or other device that performs monitoring and/or measurements, and transmits the results of such monitoring and/or measurements to another UE or terminal device and/or a network equipment. In this case, the UE or terminal device may be a machine-to-machine (M2M) device, which may, in a 3GPP context, be referred to as a machine-type communication (MTC) device. Particular examples of such machines or devices may include sensors, metering devices such as power meters, industrial machineries, bikes, vehicles, or home or personal appliances, e.g. refrigerators, televisions, personal wearables such as watches, and so on.

As used herein, the term “communication system” refers to a system following any suitable communication standards, such as the first generation (1G), 2G, 2.5G, 2.75G, 3G, 4G, 4.5G, 5G communication protocols, and/or any other protocols either currently known or to be developed in the future. Furthermore, the communications between a terminal device and a network node in the communication system may be performed according to any suitable generation communication protocols, including, but not limited to, 1G, 2G, 2.5G, 2.75G, 3G, 4G, 4.5G, 5G communication protocols, and/or any other protocols either currently known or to be developed in the future. In addition, the specific terms used herein do not limit the present disclosure only to the communication system related to the specific terms, which however can be more generally applied to other communication systems.

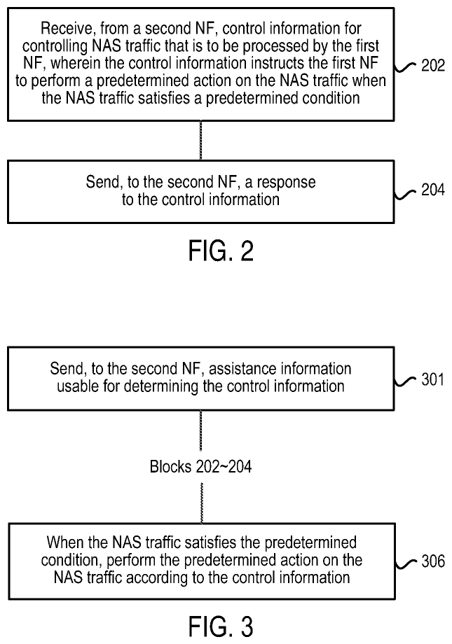

FIG. 2 is a flowchart illustrating a method performed by a first network function (NF) according to an embodiment of the disclosure. For example, the first NF may be an AMF, or an SMF, or an NEF, or an SMSF, or any other NF which is in a chain of NFs processing NAS traffic but is not the last node in the chain. Note that the network function (or network entity) mentioned in this document may be implemented either as a network element on a dedicated hardware, as a software instance running on a dedicated hardware, or as a virtualized function instantiated on an appropriate platform, e.g. on a cloud infrastructure. At block 202, the first NF receives, from a second NF, control information for controlling NAS traffic that is to be processed by the first NF. The control information instructs the first NF to perform a predetermined action on the NAS traffic when the NAS traffic satisfies a predetermined condition. For example, the second NF may be an NWDAF, or an O&M, or any other NF having similar functionality. The predetermined action may be one of accepting the NAS traffic, rejecting the NAS traffic, and ignoring the NAS traffic.

As an exemplary example, the control information may comprise a first identifier (ID) identifying a target NF for which the control is applied to the NAS traffic (or to which the controlled NAS traffic is sent), a first indicator indicating at least one rule for defining the predetermined condition, and a second indicator indicating the predetermined action. The target NF may be any NF which has a reference point with the first NF. In the case that the first NF is an AMF, examples of the target NF may include, but not limited to, an SMF, a UDM, an NSSF, an AUSF, a PCF, a different AMF, an NEF, an AF, etc. In the case that the first NF is an SMF, examples of the target NF may include, but not limited to, an AMF, a PCF, a UDM, an NEF, an AF, etc. In the case that the first NF is an NEF, examples of the target NF may include, but not limited to, an AMF, an SMF, a UDM, an AF, etc. In the case that the first NF is an SMSF, examples of the target NF may include, but not limited to, an AMF, a UDM, an NEF, an AF, etc.

The at least one rule may comprise, but not limited to, one or more of: a first rule indicating that the control should be applied to the NAS traffic of any terminal device; a second rule indicating that the control should be applied to the NAS traffic of a specific terminal device; a third rule indicating that the control should be applied in one or more specific events; a fourth rule indicating that the control should be applied to the NAS traffic related to a specific data network name (DNN); a fifth rule indicating that the control should be applied to the NAS traffic related to a specific protocol data unit (PDU) session; a sixth rule indicating that the control should be applied to the NAS traffic of one or more terminal devices at a specific location; and a seventh rule indicating that the control should be applied to the NAS traffic having a specific traffic pattern.

For instance, the first indicator may have at least one sub-indicator each indicating one of the at least one rule. The sub-indicator for the first rule may be a Boolean parameter which may take the value of “TRUE” to indicate that the control should be applied to the NAS traffic of any terminal device, or take the value of “FALSE” to indicate that the control is not applied to the NAS traffic of any terminal device. The sub-indicator for the second rule may be an ID of a terminal device whose NAS traffic should be controlled. The sub-indicator for the third rule may be a list of one or more events in which the control should be applied to the NAS traffic. The sub-indicator for the fourth rule may indicate a DNN to which the NAS traffic to be controlled is related. The sub-indicator for the fifth rule may be a PDU session ID identifying a PDU session to which the NAS traffic to be controlled is related. The sub-indicator for the sixth rule may indicate a location of one or more terminal devices whose NAS traffic should be controlled. The sub-indicator for the seventh rule may indicate a traffic pattern of the NAS traffic to be controlled.

As an exemplary example, the NAS traffic having the specific traffic pattern may be an NAS traffic (e.g. an NAS message such as an SMS message for small data delivery) whose payload is an IP based packet having a specific feature in content. The IP based packet may comprise, but not limited to, one or more of: an Internet control message protocol (ICMP) packet, a transmission control protocol (TCP) packet, a user datagram protocol (UDP) packet, a stream control transmission protocol (SCTP) packet, etc. For example, the specific feature may be a feature in the packet header of the IP based packet which may be determined according to the actual requirement in the specific application scenario (e.g. if the packet header has a specific feature, the IP based packet can be ignored or accepted). Such feature may be represented in any suitable way such as U32 rules.

Optionally, the control information may further comprise one or more of: a second ID identifying the control information; and a third indicator indicating a validity time of the control information. With the second ID, it is possible to query statistics of specific control information. The third indicator may indicate a specific time period during which the control should be applied to the NAS traffic. The absence of the third indicator may indicate that the control according to the control information is permanent.

At block 204, the first NF sends, to the second NF, a response to the control information. If the control according to the control information can be successfully initiated, the response may indicate that the control applied to the NAS traffic is initiated. On the other hand, if the control according to the control information cannot be successfully initiated, the response may indicate why the control applied to the NAS traffic cannot be initiated. With the method of FIG. 2, it is possible to configure control information for NAS traffic.

FIG. 3 is a flowchart illustrating a method performed by a first NF according to an embodiment of the disclosure. As shown, the method comprises block 301, blocks 202-204 described above, and block 306. At block 301, the first NF sends, to a second NF, assistance information usable for determining control information. The control information is for controlling NAS traffic that is to be processed by the first NF. The second NF and the control information have been described above with respect to block 202. The assistance information may comprise, but not limited to, one or more of: at least one key performance indicator (KPI) related to the NAS traffic, at least one counter for checking health status of the first network function, a log of events occurring at the first network function, the NAS traffic processed by the first network function, etc.

The at least one KPI may include, but not limited to, registration success rate, paging success rate, tracking area update (TAU) success rate, etc. The at least one counter may include, but not limited to, a counter for counting the number of connections with other NFs, a counter for counting the number/size of messages communicated on each connection, a counter for counting the throughput per minute on each connection, a counter for counting the number of total users/active users/PDUs, a counter for counting the usage rate of CPU/memory/disk of the first NF. For instance, the log of events may be event based monitoring (EBM) log. Note that it is possible for another NF related to the first NF to send the assistance information to the second NF. Thus, block 301 may be an optional block.

At block 202, the first NF receives, from the second NF, the control information for controlling NAS traffic that is to be processed by the first NF. The control information instructs the first NF to perform a predetermined action on the NAS traffic when the NAS traffic satisfies a predetermined condition. At block 204, the first NF sends, to the second NF, a response to the control information. At block 306, when the NAS traffic satisfies the predetermined condition, the first NF performs the predetermined action on the NAS traffic according to the control information. For example, the first NF may determine whether the NAS traffic matches the at least one rule in the control information. When the NAS traffic matches the at least one rule, the predetermined action may be performed on the NAS traffic. With the method of FIG. 3, it is possible to implement efficient control for NAS traffic. In particular, in the case that the first NF is an AMF, it is possible to discard abnormal NAS traffic at the AMF so as to avoid waste of network resources.

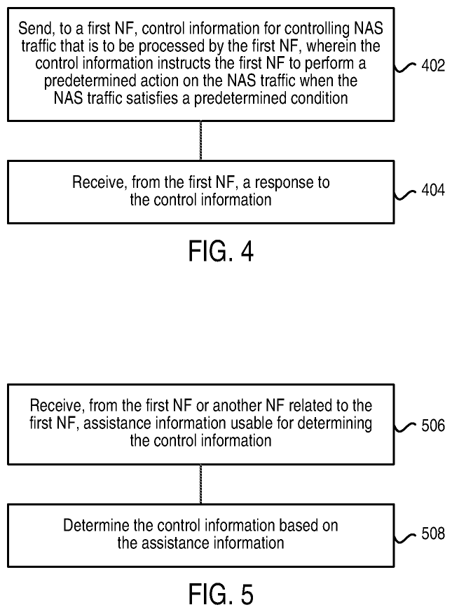

FIG. 4 is a flowchart illustrating a method performed by a second NF according to an embodiment of the disclosure. For example, the second NF may be an NWDAF, or an O&M, or any other NF having similar functionality. At block 402, the second NF sends, to a first NF, control information for controlling NAS traffic that is to be processed by the first NF. The control information instructs the first NF to perform a predetermined action on the NAS traffic when the NAS traffic satisfies a predetermined condition. The first NF may be an AMF, or an SMF, or an NEF, or an SMSF, or any other NF which is in a chain of NFs processing NAS traffic but is not the last node in the chain. The predetermined action may be one of accepting the NAS traffic, rejecting the NAS traffic, and ignoring the NAS traffic. The details of the control information have been described above with respect to block 202. At block 404, the second NF receives, from the first NF, a response to the control information. The response may either indicate that the control applied to the NAS traffic is initiated, or indicate why the control applied to the NAS traffic cannot be initiated. With the method of FIG. 4, it is possible to configure control information for NAS traffic.

FIG. 5 is a flowchart illustrating a method performed by a second NF according to an embodiment of the disclosure. At block 506, the second NF receives, from the first NF or another NF related to the first NF, assistance information usable for determining the control information. The another NF related to the first NF may be an NF which is in a chain of NFs processing NAS traffic and is next to the first NF in the chain. The assistance information may comprise, but not limited to, one or more of: at least one KPI related to the NAS traffic, at least one counter for checking health status of the first network function, a log of events occurring at the first network function, the NAS traffic processed by the first network function, etc. Further details of the assistance information have been described above with respect to block 301.

At block 508, the second NF determines the control information based on the assistance information. As an exemplary example, a machine learning process (e.g. isolation forest (iForest) algorithm, K-NearestNeighbor (KNN), kernel density estimation (KDE), support vector machines (SVM), Autoencoder, Long short-term memory (LSTM), etc.) may be performed so that a model can be trained by using historical assistance information and then the trained model can be used for detecting abnormal NAS traffic based on current assistance information. Then, the feature(s) of the abnormal NAS traffic may be extracted so as to generate corresponding rule(s) matching the extracted feature(s). Then, the control information may be determined to ignore the abnormal NAS traffic. Note that any other suitable anomaly detection techniques may be used instead. With the method of FIG. 5, the control information for NAS traffic can be generated so as to implement efficient NAS traffic control.

Based on the above description, the present disclosure allows NF to support NAS traffic control to expose its ability to other NF. In this way, it is possible to do dynamic traffic control based on real-time traffic. Particular example is to throttle unexpected network burst. The present disclosure also proposes the control information structure describing the NAS traffic in different dimension which guarantees finer granular control. Besides the traditional rate control, it could perform NF or UE level traffic control, or even content-based NAS traffic control.

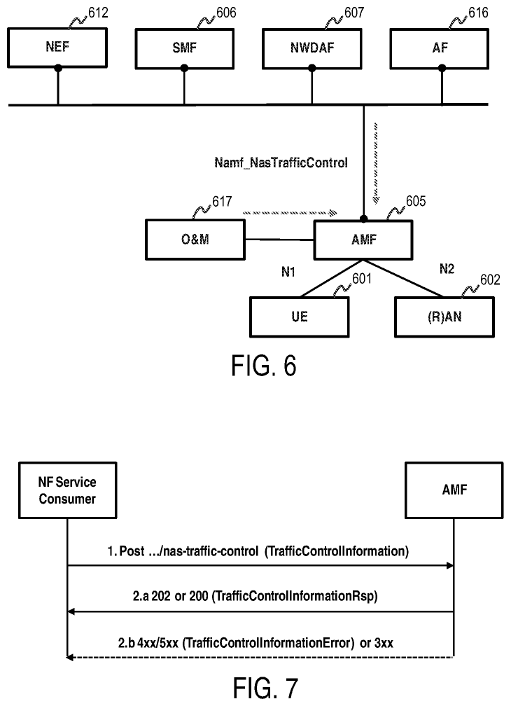

For ease of understanding, FIG. 6 illustrates an exemplary embodiment of the disclosure where the first NF is an AMF so that AMF NAS traffic control service is newly introduced. As shown, the communication system comprises a UE 601, a (R)AN 602, an AMF 605, an SMF 606, an NWDAF 607, an NEF 612, AF 616, and O&M 617. A new private Namf_NasTrafficControl service may be used by an NF (e.g. the SMF 606, or the NEF 612, or the AF 616, or the NWDAF 607) or the O&M 617 to request the AMF for initiating NAS traffic control and provide the statistics of NAS traffic control. The following are key functionalities of the service: 1) allowing NFs to set traffic control rules to AMF and let AMF to alter the network traffic accordingly (e.g., drop the session related message if UE id matches the dropping rule); 2) allowing NFs to request the statistics of given rules.

The traffic control information mainly comprises: 1) Target, which indicates target NF of the rule so that each NF instance could have its own customized traffic rules set on AMF; 2) Rule, which is implementation dependent and could contain UE Id, Event id, traffic patterns, etc; 3) Action, which is Enum type and the value range is ACCEPT or IGNORE or REJECT. The Action can let AMF to accept (i.e. handle as normal), ignore or reject the matched traffic.

FIG. 7 is a flowchart illustrating an exemplary process according to an embodiment of the disclosure. It shows how other NFs set TrafficControlInformation on AMF. At step 1, the NF Service Consumer shall send a POST request to set TrafficControlInformation on AMF. At step 2.a, on success (i.e. if the request is accepted and the AMF is able to handle the TrafficControlInformation), the AMF shall respond with a “200 OK” status code. The AMF shall set the cause information element (IE) in the TrafficControlInformationRsp as “TRAFFIC_CONTROL_INITIATED” in this case. At step 2.b, on failure, one of the HTTP status code shall be returned. For a 4xx/5xx response, the message body shall contain a NIN2MessageTransferError structure, including a ProblemDetails structure with the “cause” attribute. A new private IE “TrafficControlInformationError” may be introduced for this purpose.

Table 1 to Table 3 below gives reference definition of the new service's IEs.

TABLE 1
TrafficControlInformation

| | | | | |
|---|---|---|---|---|
| | | | | the Traffic Control |
| | | | | Information. |
| Rule | TrafficControlRule | M | 1 | Traffic Control Rule which |
| | | | | is supported by AMF |
| Action | TrafficControlAction | M | 1 | Enum type. Could be |
| | | | | “ACCEPT”, “REJECT” or |
| | | | | “IGNORE” |
| Validity Time | DateTime | O | 0 . . . 1 | Validity time of current |
| | | | | control rule. If not |
| | | | | present, means the rule is |
| | | | | permanent. |

TABLE 2
TrafficControlInformationRsp

| | | | | | |
|---|---|---|---|---|---|
| Attribute | | | | | |
| name | Data type | P | Cardinality | Description | Applicability |

| | | | | |
|---|---|---|---|---|
| Cause | TraffiControlCause | M | 1 | Enum type. |
| | | | | “TRAFFIC_CONTROL_INITIATED” |

TABLE 3
TrafficControlRule

| | | | | | |
|---|---|---|---|---|---|
| Attribute | | | | | |
| name | Data type | P | Cardinality | Description | Applicability |

| | | | | |
|---|---|---|---|---|
| AnyUE | Boolean | C | 0 . . . 1 | If present, the rule should be apply to |
| | | | | all UE's traffic. Default is FALSE |
| UE Id | SUPI | C | 0 . . . 1 | If present, the rule only apply to one |
| | | | | UE's traffic. |
| Events | Array(event) | O | 0 . . . N | Event could be list of |
| | | | | “AMF_DEREGISTRATION”, |
| | | | | “AMF_HANDOVER”, |
| | | | | “AMF_INITIAL_REGISTRATION”, |
| | | | | “AMF_PAGING”, |
| | | | | “AMF_PDU_SESSION_ESTABLISHMENT”, |
| | | | | “AMF_REGISTRATION_UPDATE”, |
| | | | | “AMF_SERVICE_REQUEST” |
| DNN | Dnn | O | 0 . . . 1 | Dnn for match |
| PduSessionId | PduSessionId | O | 0 . . . 1 | Pdu Session Id for the rule |
| Location | UserLocation | O | 0 . . . 1 | Represents the location information |
| | | | | of the UE for matching |
| RawRule | Ip rules | O | 0 . . . 1 | Traffic pattern. Implement dependent. |
| | | | | e.g Raw rules for small data over |
| | | | | NAS or SMS. Could be used to |
| | | | | match the content of payload |

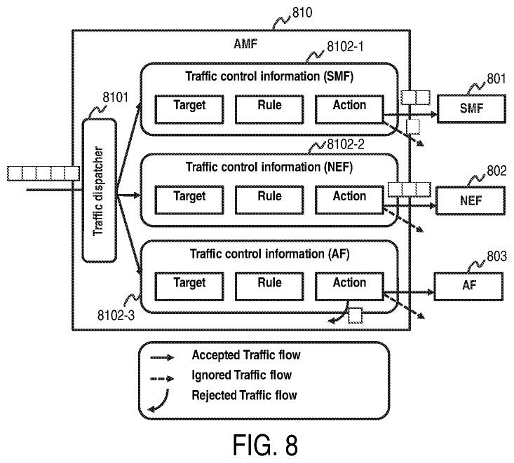

FIG. 8 illustrates the internal handling of an AMF after TrafficControlInformation (e.g. 8102-1, 8102-2, 8102-3) is received from other NFs. As shown, when any N1/N2 message is received from a UE or a next generation RAN (NG-RAN), the AMF 810 checks if there are any rules that have been set by a target NF or O&M. If the incoming traffic matches a rule, the action of the rule is applied to the package. In the example shown in FIG. 8, after being dispatched by the traffic dispatcher 8101, some packages targeting the SMF 801 are accepted and others are ignored, packages targeting the NEF 802 are accepted, and the package targeting the AF 803 is rejected.

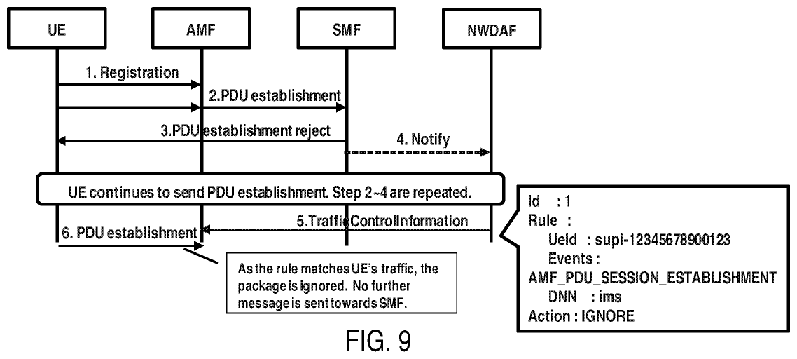

FIG. 9 is a flowchart illustrating an exemplary process according to an embodiment of the disclosure. This process relates to the signaling of abnormal UE session being throttled via AMF. In this process, the NWDAF found that one PDU session establishment from one UE always failed due to mismatch in subscription data. Then, the NWDAF sets TrafficControlInformation to the AMF indicating the abnormal SUPI, events and DNN information. The AMF then could ignore the UE's session traffic so that the signaling between the AMF and the SMF could be reduced.

At step 1, the UE initiates Registration procedure and is successfully registered in the 5GC. At step 2, the UE initiates PDU session establishment procedures towards the 5GC. The message is received by the AMF and then forwarded to the SMF for further handling. At step 3, the Request from the UE is rejected. Due to misconfiguration in the UE, the DNN requested by the UE is not allowed in the subscription data. The SMF rejects the PDU establishment and sends the PDU establishment reject message to the UE via the AMF.

At step 4, the SMF (or the AMF) notifies the NWDAF. The SMF (or the AMF) sends KPI, counters and logs to the NWDAF periodically so that the NWDAF could do run-time performance analysis and anomaly detection. Meanwhile, before any actions are taken, the UE continues to send PDU establishment request and get rejected by the 5GC. The traffic rate of this kind could be high in live network.

At step 5, the NWDAF applies a rule to the AMF. From the run-time KPI and counters collected in step 4, the NWDAF finds that there is a problem in PDU establishment procedures. Then the NWDAF starts to analyze the logs like event based monitoring (EBM) log and counters. With proper algorithm, the NWDAF figures out the pattern of the abnormal UE along with its ID. Then, the NWDAF generates the corresponding TrafficControlInformation and sends the rule to the AMF.

At step 6, the abnormal UE's traffic gets throttled. After the AMF receives the TrafficControlInformation, it will match the UE's traffic with the rule. When the UE's supi is “1234568900123” and the requested DNN is “ims”, the AMF ignores the request silently. By doing so, the abnormal traffic is ended at the AMF without impacting the backend NF like the SMF. Despite the “IGNORE” action, it is also possible for the NWDAF to include “REJECT” action in the TrafficControlInformation. Depending on the local policy in the AMF, the AMF rejects the UE's request with proper NAS cause code along with certain backoff timer. This could further reduce the abnormal traffic in random access (RA).

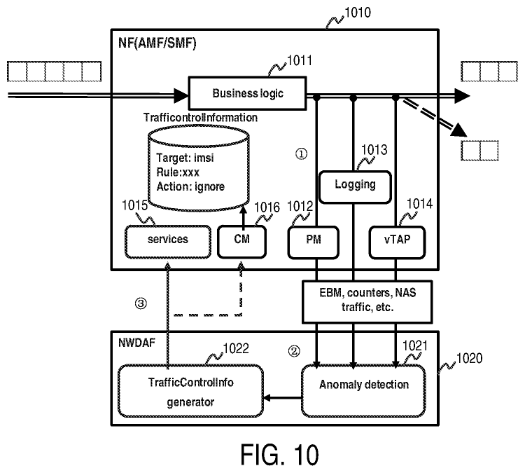

FIG. 10 is a diagram illustrating an exemplary process according to an embodiment of the disclosure. This process relates to the detailed signaling flow between the NF (the SMF/AMF) and the NWDAF in FIG. 9. As shown, the NF 1010 comprises a business logic block 1011, a performance management (PM) block 1012, a logging block 1013 and a vTAP block 1014. The term vTAP refers to virtual terminal access point which is a component capable of capturing packets in cloud environment. The UEs' requests can be handled by the business logic block 1011. The PM block 1012 can generate KPI like registration, paging, TAU success rate, etc. PM block 1012 can also generate counters of the NF which might be used by the NWDAF 1020 for the NF's health check. The logging block 1013 can provide logs (containing e.g. EBM logs) which can enable the NWDAF 1020 to have detailed insight for each UE's mobility/session events. The vTAP block 1014 can be used for NAS traffic monitoring. All decoded NAS messages related to UE(s) can be copied and sent from the NF 1010 to the NWDAF 1020.

The PM block 1012, the logging block 1013 and the vTAP block 1014 may send the run-time KPI, counters, logs (e.g. EBM logs) and the NAS traffic (e.g. decoded NAS packages) to the NWDAF 1020. The NWDAF 1020 may process the data and apply anomaly detection algorithm by the anomaly detection block 1021 to figure out the abnormal UE. Based on the UE's pattern, the NWDAF 1020 may construct TrafficControlInformation (see e.g. Table 1˜3 described above) by the TrafficControlInfo generator 1022.

The NWDAF 1020 may send the TrafficControlInformation to the NF 1010 (e.g. the services block 1015). Then, the NF 1010 could filter the abnormal UE's NAS traffic. Optionally, if the NWDAF 1020 could access the configuration management (CM) block 1016, the NWDAF 1020 could configure the control rule on the NF directly.

For anomaly detection of UE, different approaches could be used. As an option, statistics may be used to find the abnormal UE. For instance, when a UE is frequently rejected by the NF, the UE could be treated as abnormal.

As another option, iForest algorithm may be used. When the amount of normal UEs overwhelms the amount of abnormal UEs, the algorithm could work well to find the outliers. For the input data of the iForest, in each training interval, the NWDAF 1020 may construct one vector for each UE mainly containing: 1) UE Id, including SUPI (IMSI), IMEI and GPSI (MSISDN); 2) TimeStamp, which is timestamp of UE activities; 3) Event Id array, e.g. the number of procedures like DEREGISTRATION, HANDOVER, INITIAL_REGISTRATION, PAGING, PDU_SESSION_ESTABLISHMENT, REGISTRATION_UPDATE, SERVICE_REQUEST, etc.; 4) Event result array: for each event id, the NWDAF may maintain one array to record the number of success, reject, abort, ignore of each event; 5) CauseCode array: for procedures ending up with reject or ignore, the NWDAF may use one array to store the NAS or hypertext transfer protocol (HTTP) cause code; 6) location information, such as tracking area identity (TAI), eNodeB/gNodeB Id and CellId; 7) Session information, such as DNN (access point name (APN)), QoS class identifier (QCI), allocation retention priority (ARP), etc.; 8) SubCauseCode array which is the internal sub cause code generated by the NF; the NWDAF may use this supplementary information to improve the accuracy of the algorithm without knowing the actual meaning of each sub cause code. The term IMSI refers to international mobile subscriber identity, the term IMEI refers to international mobile equipment identity, the term GPSI refers to generic public subscription identifier, the term MSISDN refers to mobile station international ISDN number, and the term ISDN refers to integrated services digital network. The term eNodeB refers to evolved node B, and the term gNodeB refers to next generation node B. The term QoS refers to quality of service.

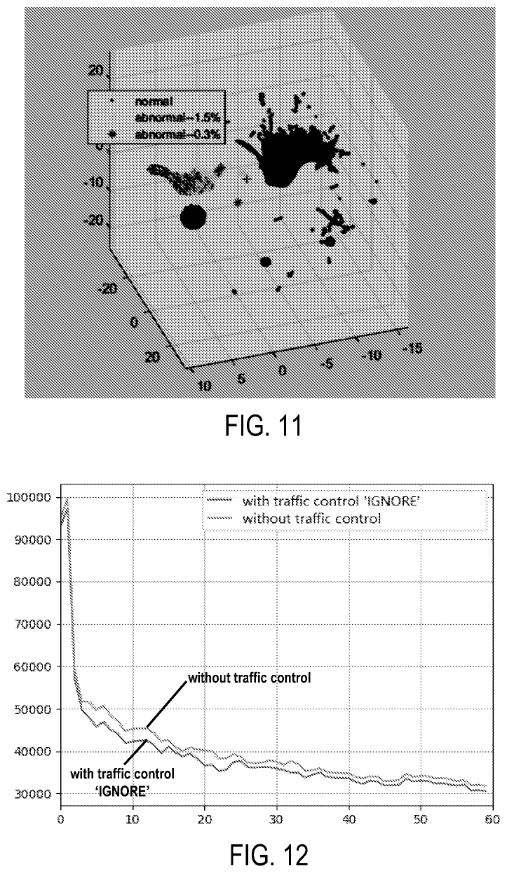

FIG. 11 shows the distribution of normal UEs and abnormal UEs from the iForest algorithm. The normal UEs are marked as dark-colored dots, while the abnormal UEs are marked as light-colored crosses and dark-colored stars separately based on the hyper-parameter chosen for the algorithm. After the iForest algorithm has classified UEs into normal and abnormal, the NWDAF may further check if the abnormal UE's traffic could be throttled by the AMF and generate the TrafficControlInformation according to the abnormal pattern.

To estimate the performance of the solution, a simulation was run. Because there is not much 5G traffic available, the traffic model was generated from real 4G network data. Procedures mapping (e.g. attach being mapped to registration, PDN connectivity being mapped to PDU establishment) was performed to estimate the network performance of the 5GC. The detailed setup of the simulated traffic is as below: 1) 10000 UEs in total; 2) 60 minutes simulation, generating traffic based on the real network data; 3) among all 10000 UEs, there is one abnormal UE which frequently fails in PDU session establishment due to missing configuration in subscription data; 4) the signaling between the AMF and the SMF is evaluated (as the abnormal UE only has problem with its session). FIG. 12 illustrates the simulation results of N11 traffic with/without traffic control. The curve above is the total signaling from the simulation. The curve below is the one obtained when the traffic control is enabled. It shows that the amount of signaling between the AMF and the SMF could reduce about 2˜8%. Note that the signaling spike in the beginning was caused by the restart of the mobility management entity (MME) in the real 4G network data.

In 5GC, small packages (e.g. in IoT or SMS application scenario) could go through AMF. For this kind of application, with the TrafficControlInformation, it is possible to turn AMF into a frontend firewall to prevent backend AF from distributed denial of service attack (DDoS) or overload. This allows other NFs or AFs to customize traffic control rules on the AMF in run-time.

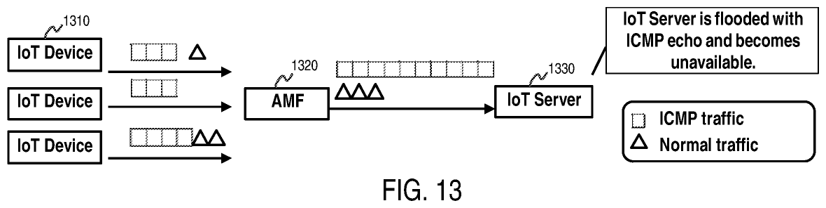

FIG. 13 illustrates the example of IoT DDOS attack with ping flood. Ping flood is a common DDOS attack in which an attacker takes down a victim's computer by overwhelming it with ICMP echo requests. If massive IoT device 1310 utilizing 5G is hacked by an attacker and initiates ping flood against one server 1330, it is likely that the backend server 1330 will become unavailable.

The 5GC has existing solutions like small data rate control which could limit the total message rate from one device. But it is not intelligent as it could not distinguish abnormal traffic. When the message quota is used up by ping flood, the IoT device could not send any data.

Normally, this kind of traffic control is done like firewall or access control list (ACL) in IP layer. However, the existing solution might not help in this scenario as the payload data is encrypted in NAS on N1/N2 or HTTPs on service based interface (SBI) interface. It is very hard for traditional methods to sniff out the encrypted payload in NAS layer and do traffic control accordingly. To solve this problem, u32 rules are introduced into NAS package handling in the NF.

U32 rules (see e.g. https://www.commandlinux.com/man-page/man8/iptables-extensions.8.html) test whether quantities of up to 4 bytes extracted from an IP packet have specified values. The specification of what to extract is not only capable of handling IP layer packet, but also general enough to find data at given offsets which allows user to handle any upper layer protocol like TCP, UDP headers.

U32 rules follow the syntax as below.
u32:=location “=” value|u32 “&&” location “=” value
value:=range|value “,” range
range:=number|number “:” number
a single number, n, is interpreted the same as n:n. n:m is interpreted as the range of numbers >=n and <=m.
location:=number|location operator number
operator:=“&” |“<<”|“>>”|“@”

The operators &, <<, >> and && mean the same as in C. The = is really a set membership operator and the value syntax describes a set. The @ operator is what allows moving to the next header.

The structure of IPV4 packet is shown in Table 4 below.

TABLE 4
structure of IPv4 packet

| | | | |
|---|---|---|---|
| Bits 0-7 | Bits 8-15 | Bits 16-23 | Bits 24-31 |

| | | | | |
|---|---|---|---|---|
| Octet0-3 | Version | IHL | TOS | Total Length |

| | | | |
|---|---|---|---|
| Octet4-7 | IP Id | Flags | Frag offset |

| | | | |
|---|---|---|---|
| Octet8-11 | TTL | Protocol | Checksum |

| | |
|---|---|
| Octet12-15 | Source IP Address |
| Octet16-19 | Destination IP Address |
| Octet20- | Upperlayer payload |

Some typical examples are given below to show how U32 rule matches payload based on IPv4 header. The first example is that U32 matches all ICMP package, “6&0xFF=1”. The first “6” means starting from octet6 and extracting 32 bits from IP header. From octet6 to octet9, it contains the Flags, Frag offset, TTL and Protocol fields. The “&0xFF” means bitwise and operations to the 32 bits we just extracted, i.e. extracting the value of Octet 9. The last “=1” checks if the value of Octet 9 equals 1. Protocol number of ICMP is 1. If the whole U32 matches, the package should be an IPV4 ICMP package.

The second example is that U32 matches destination IP being 224.0.0.1, “16=0xE0000001”. The first “16” means starting from octet 16 and extracting 32 bits from IP header. From octet16 to octet19, it is the destination IP address. Then the “=0xE0000001” is the hex format of 224.0.0.1.

The third example is that U32 matches destination port being 53, “0>>22&0x3C@0&0xFFFF=53”. “0>>22&0x3C@0” means to skip the IP header. In more straight way, it could be rewrite as “0>>24&0x0F<<2@0”. Firstly, the IHL field is extracted from first octet. As the IHL filed counts package in words, we need left shift 2 to multiply 4 to get the actual length. Then, we skip the bytes indicated by IHL field. The trick here is we want to save one shift operation. We only shift 22 instead of 24 and use a mask of 0x3C instead of 0x0F so that we could directly get the IP header length in bytes. After IP header is skipped, we check if the least significant two bytes equals to 53.

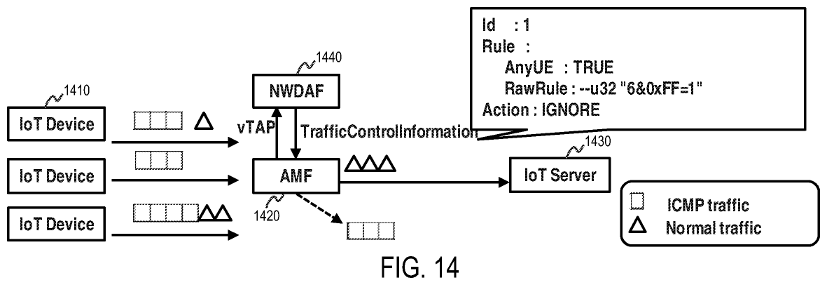

FIG. 14 illustrates the NAS Traffic Control according to an exemplary embodiment to prevent DDOS attack. With the exemplary embodiment, the AMF 1420 can be enabled to filter the NAS ICMP packages (assuming the payload from the IoT device 1410 is pure IPv4 package). As shown, the AMF 1420 copies IoT devices' decoded NAS payload and sends it to the NWDAF 1440 via the vTAP block. The NWDAF 1440 perform anomaly detection on IoT devices' NAS traffic. The NWDAF finds pattern of ping flood and apply U32 rule to ignore ICMP packages. After U32 rule is applies on the AMF 1420, the AMF 1420 checks every NAS package from the IoT devices 1410. If U32 rules matches the NAS package, the AMF 1420 drops the NAS package. By doing so, the IoT server 1430 will no longer receive any unwanted ICMP package. Note that the normal traffic from the IoT Devices 1410 is not impacted by U32 ICMP rules. This provides flexibility for customer or other NF to perform fine granular level of traffic control.

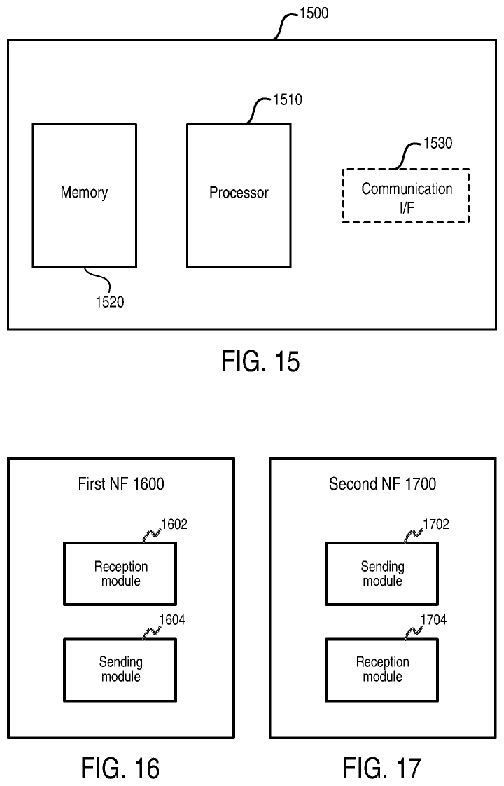

FIG. 15 is a block diagram showing an apparatus suitable for use in practicing some embodiments of the disclosure. For example, any one of the first NF and the second NF described above may be implemented through the apparatus 1500. As shown, the apparatus 1500 may include a processor 1510, a memory 1520 that stores a program, and optionally a communication interface 1530 for communicating data with other external devices through wired and/or wireless communication.

The program includes program instructions that, when executed by the processor 1510, enable the apparatus 1500 to operate in accordance with the embodiments of the present disclosure, as discussed above. That is, the embodiments of the present disclosure may be implemented at least in part by computer software executable by the processor 1510, or by hardware, or by a combination of software and hardware.

The memory 1520 may be of any type suitable to the local technical environment and may be implemented using any suitable data storage technology, such as semiconductor based memory devices, flash memories, magnetic memory devices and systems, optical memory devices and systems, fixed memories and removable memories. The processor 1510 may be of any type suitable to the local technical environment, and may include one or more of general purpose computers, special purpose computers, microprocessors, digital signal processors (DSPs) and processors based on multi-core processor architectures, as non-limiting examples.

FIG. 16 is a block diagram showing an apparatus implementing a first NF according to an embodiment of the disclosure. As shown, the apparatus 1600 comprises a reception module 1602 and a sending module 1604. The reception module 1602 may be configured to receive, from a second NF, control information for controlling NAS traffic that is to be processed by the first NF, as described above with respect to block 202. The control information instructs the first NF to perform a predetermined action on the NAS traffic when the NAS traffic satisfies a predetermined condition. The sending module 1604 may be configured to send, to the second NF, a response to the control information, as described above with respect to block 204.

FIG. 17 is a block diagram showing an apparatus implementing a second NF according to an embodiment of the disclosure. As shown, the apparatus 1700 comprises a sending module 1702 and a reception module 1704. The sending module 1702 may be configured to send, to a first NF, control information for controlling NAS traffic that is to be processed by the first NF, as described above with respect to block 402. The control information instructs the first NF to perform a predetermined action on the NAS traffic when the NAS traffic satisfies a predetermined condition. The reception module 1704 may be configured to receive, from the first NF, a response to the control information, as described above with respect to block 1704. The modules described above may be implemented by hardware, or software, or a combination of both.

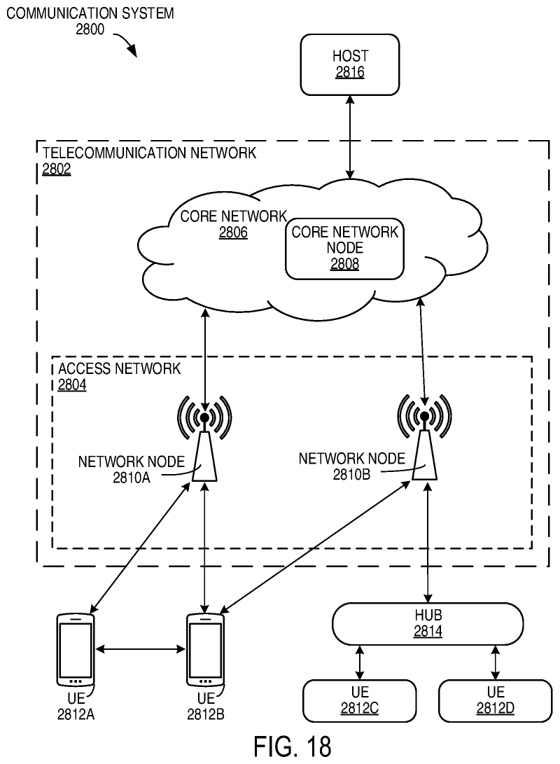

FIG. 18 shows an example of a communication system 2800 in accordance with some embodiments.

In the example, the communication system 2800 includes a telecommunication network 2802 that includes an access network 2804, such as a radio access network (RAN), and a core network 2806, which includes one or more core network nodes 2808. The access network 2804 includes one or more access network nodes, such as network nodes 2810a and 2810b (one or more of which may be generally referred to as network nodes 2810), or any other similar 3rd Generation Partnership Project (3GPP) access node or non-3GPP access point. The network nodes 2810 facilitate direct or indirect connection of user equipment (UE), such as by connecting UEs 2812a, 2812b, 2812c, and 2812d (one or more of which may be generally referred to as UEs 2812) to the core network 2806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 2800 may include any number of wired or wireless networks, network nodes, UEs, and/or any other components or systems that may facilitate or participate in the communication of data and/or signals whether via wired or wireless connections. The communication system 2800 may include and/or interface with any type of communication, telecommunication, data, cellular, radio network, and/or other similar type of system.

The UEs 2812 may be any of a wide variety of communication devices, including wireless devices arranged, configured, and/or operable to communicate wirelessly with the network nodes 2810 and other communication devices. Similarly, the network nodes 2810 are arranged, capable, configured, and/or operable to communicate directly or indirectly with the UEs 2812 and/or with other network nodes or equipment in the telecommunication network 2802 to enable and/or provide network access, such as wireless network access, and/or to perform other functions, such as administration in the telecommunication network 2802.

In the depicted example, the core network 2806 connects the network nodes 2810 to one or more hosts, such as host 2816. These connections may be direct or indirect via one or more intermediary networks or devices. In other examples, network nodes may be directly coupled to hosts. The core network 2806 includes one more core network nodes (e.g., core network node 2808) that are structured with hardware and software components. Features of these components may be substantially similar to those described with respect to the UEs, network nodes, and/or hosts, such that the descriptions thereof are generally applicable to the corresponding components of the core network node 2808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2816 may be under the ownership or control of a service provider other than an operator or provider of the access network 2804 and/or the telecommunication network 2802, and may be operated by the service provider or on behalf of the service provider. The host 2816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2800 of FIG. 18 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2802 is a cellular network that implements 3GPP standardized features. Accordingly, the telecommunications network 2802 may support network slicing to provide different logical networks to different devices that are connected to the telecommunication network 2802. For example, the telecommunications network 2802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 2812 are configured to transmit and/or receive information without direct human interaction. For instance, a UE may be designed to transmit information to the access network 2804 on a predetermined schedule, when triggered by an internal or external event, or in response to requests from the access network 2804. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 2814 communicates with the access network 2804 to facilitate indirect communication between one or more UEs (e.g., UE 2812c and/or 2812d) and network nodes (e.g., network node 2810b). In some examples, the hub 2814 may be a controller, router, content source and analytics, or any of the other communication devices described herein regarding UEs. For example, the hub 2814 may be a broadband router enabling access to the core network 2806 for the UEs. As another example, the hub 2814 may be a controller that sends commands or instructions to one or more actuators in the UEs. Commands or instructions may be received from the UEs, network nodes 2810, or by executable code, script, process, or other instructions in the hub 2814. As another example, the hub 2814 may be a data collector that acts as temporary storage for UE data and, in some embodiments, may perform analysis or other processing of the data. As another example, the hub 2814 may be a content source. For example, for a UE that is a VR headset, display, loudspeaker or other media delivery device, the hub 2814 may retrieve VR assets, video, audio, or other media or data related to sensory information via a network node, which the hub 2814 then provides to the UE either directly, after performing local processing, and/or after adding additional local content. In still another example, the hub 2814 acts as a proxy server or orchestrator for the UEs, in particular in if one or more of the UEs are low energy IoT devices.

The hub 2814 may have a constant/persistent or intermittent connection to the network node 2810b. The hub 2814 may also allow for a different communication scheme and/or schedule between the hub 2814 and UEs (e.g., UE 2812c and/or 2812d), and between the hub 2814 and the core network 2806. In other examples, the hub 2814 is connected to the core network 2806 and/or one or more UEs via a wired connection. Moreover, the hub 2814 may be configured to connect to an M2M service provider over the access network 2804 and/or to another UE over a direct connection. In some scenarios, UEs may establish a wireless connection with the network nodes 2810 while still connected via the hub 2814 via a wired or wireless connection. In some embodiments, the hub 2814 may be a dedicated hub—that is, a hub whose primary function is to route communications to/from the UEs from/to the network node 2810b. In other embodiments, the hub 2814 may be a non-dedicated hub—that is, a device which is capable of operating to route communications between the UEs and network node 2810b, but which is additionally capable of operating as a communication start and/or end point for certain data channels.

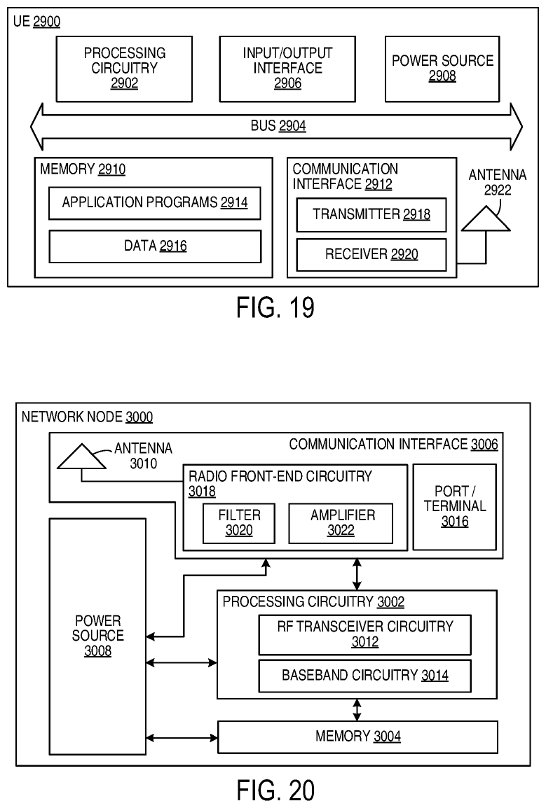

FIG. 19 shows a UE 2900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 2900 includes processing circuitry 2902 that is operatively coupled via a bus 2904 to an input/output interface 2906, a power source 2908, a memory 2910, a communication interface 2912, and/or any other component, or any combination thereof. Certain UEs may utilize all or a subset of the components shown in FIG. 19. The level of integration between the components may vary from one UE to another UE. Further, certain UEs may contain multiple instances of a component, such as multiple processors, memories, transceivers, transmitters, receivers, etc.

The processing circuitry 2902 is configured to process instructions and data and may be configured to implement any sequential state machine operative to execute instructions stored as machine-readable computer programs in the memory 2910. The processing circuitry 2902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2902 may include multiple central processing units (CPUs).

In the example, the input/output interface 2906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2908 is structured as a battery or battery pack. Other types of power sources, such as an external power source (e.g., an electricity outlet), photovoltaic device, or power cell, may be used. The power source 2908 may further include power circuitry for delivering power from the power source 2908 itself, and/or an external power source, to the various parts of the UE 2900 via input circuitry or an interface such as an electrical power cable. Delivering power may be, for example, for charging of the power source 2908. Power circuitry may perform any formatting, converting, or other modification to the power from the power source 2908 to make the power suitable for the respective components of the UE 2900 to which power is supplied.

The memory 2910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2910 includes one or more application programs 2914, such as an operating system, web browser application, a widget, gadget engine, or other application, and corresponding data 2916. The memory 2910 may store, for use by the UE 2900, any of a variety of various operating systems or combinations of operating systems.

The memory 2910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2910 may allow the UE 2900 to access instructions, application programs and the like, stored on transitory or non-transitory memory media, to off-load data, or to upload data. An article of manufacture, such as one utilizing a communication system may be tangibly embodied as or in the memory 2910, which may be or comprise a device-readable storage medium.

The processing circuitry 2902 may be configured to communicate with an access network or other network using the communication interface 2912. The communication interface 2912 may comprise one or more communication subsystems and may include or be communicatively coupled to an antenna 2922. The communication interface 2912 may include one or more transceivers used to communicate, such as by communicating with one or more remote transceivers of another device capable of wireless communication (e.g., another UE or a network node in an access network). Each transceiver may include a transmitter 2918 and/or a receiver 2920 appropriate to provide network communications (e.g., optical, electrical, frequency allocations, and so forth). Moreover, the transmitter 2918 and receiver 2920 may be coupled to one or more antennas (e.g., antenna 2922) and may share circuit components, software or firmware, or alternatively be implemented separately.

In the illustrated embodiment, communication functions of the communication interface 2912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2900 shown in FIG. 19.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 20 shows a network node 3000 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 3000 includes a processing circuitry 3002, a memory 3004, a communication interface 3006, and a power source 3008. The network node 3000 may be composed of multiple physically separate components (e.g., a NodeB component and a RNC component, or a BTS component and a BSC component, etc.), which may each have their own respective components. In certain scenarios in which the network node 3000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 3000 may be configured to support multiple radio access technologies (RATs). In such embodiments, some components may be duplicated (e.g., separate memory 3004 for different RATs) and some components may be reused (e.g., a same antenna 3010 may be shared by different RATs). The network node 3000 may also include multiple sets of the various illustrated components for different wireless technologies integrated into network node 3000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 3000.

The processing circuitry 3002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 3000 components, such as the memory 3004, to provide network node 3000 functionality.

In some embodiments, the processing circuitry 3002 includes a system on a chip (SOC). In some embodiments, the processing circuitry 3002 includes one or more of radio frequency (RF) transceiver circuitry 3012 and baseband processing circuitry 3014. In some embodiments, the radio frequency (RF) transceiver circuitry 3012 and the baseband processing circuitry 3014 may be on separate chips (or sets of chips), boards, or units, such as radio units and digital units. In alternative embodiments, part or all of RF transceiver circuitry 3012 and baseband processing circuitry 3014 may be on the same chip or set of chips, boards, or units.

The memory 3004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 3002. The memory 3004 may store any suitable instructions, data, or information, including a computer program, software, an application including one or more of logic, rules, code, tables, and/or other instructions capable of being executed by the processing circuitry 3002 and utilized by the network node 3000. The memory 3004 may be used to store any calculations made by the processing circuitry 3002 and/or any data received via the communication interface 3006. In some embodiments, the processing circuitry 3002 and memory 3004 is integrated.

The communication interface 3006 is used in wired or wireless communication of signaling and/or data between a network node, access network, and/or UE. As illustrated, the communication interface 3006 comprises port(s)/terminal(s) 3016 to send and receive data, for example to and from a network over a wired connection. The communication interface 3006 also includes radio front-end circuitry 3018 that may be coupled to, or in certain embodiments a part of, the antenna 3010. Radio front-end circuitry 3018 comprises filters 3020 and amplifiers 3022. The radio front-end circuitry 3018 may be connected to an antenna 3010 and processing circuitry 3002. The radio front-end circuitry may be configured to condition signals communicated between antenna 3010 and processing circuitry 3002. The radio front-end circuitry 3018 may receive digital data that is to be sent out to other network nodes or UEs via a wireless connection. The radio front-end circuitry 3018 may convert the digital data into a radio signal having the appropriate channel and bandwidth parameters using a combination of filters 3020 and/or amplifiers 3022. The radio signal may then be transmitted via the antenna 3010. Similarly, when receiving data, the antenna 3010 may collect radio signals which are then converted into digital data by the radio front-end circuitry 3018. The digital data may be passed to the processing circuitry 3002. In other embodiments, the communication interface may comprise different components and/or different combinations of components.

In certain alternative embodiments, the network node 3000 does not include separate radio front-end circuitry 3018, instead, the processing circuitry 3002 includes radio front-end circuitry and is connected to the antenna 3010. Similarly, in some embodiments, all or some of the RF transceiver circuitry 3012 is part of the communication interface 3006. In still other embodiments, the communication interface 3006 includes one or more ports or terminals 3016, the radio front-end circuitry 3018, and the RF transceiver circuitry 3012, as part of a radio unit (not shown), and the communication interface 3006 communicates with the baseband processing circuitry 3014, which is part of a digital unit (not shown).

The antenna 3010 may include one or more antennas, or antenna arrays, configured to send and/or receive wireless signals. The antenna 3010 may be coupled to the radio front-end circuitry 3018 and may be any type of antenna capable of transmitting and receiving data and/or signals wirelessly. In certain embodiments, the antenna 3010 is separate from the network node 3000 and connectable to the network node 3000 through an interface or port.

The antenna 3010, communication interface 3006, and/or the processing circuitry 3002 may be configured to perform any receiving operations and/or certain obtaining operations described herein as being performed by the network node. Any information, data and/or signals may be received from a UE, another network node and/or any other network equipment. Similarly, the antenna 3010, the communication interface 3006, and/or the processing circuitry 3002 may be configured to perform any transmitting operations described herein as being performed by the network node. Any information, data and/or signals may be transmitted to a UE, another network node and/or any other network equipment.

The power source 3008 provides power to the various components of network node 3000 in a form suitable for the respective components (e.g., at a voltage and current level needed for each respective component). The power source 3008 may further comprise, or be coupled to, power management circuitry to supply the components of the network node 3000 with power for performing the functionality described herein. For example, the network node 3000 may be connectable to an external power source (e.g., the power grid, an electricity outlet) via an input circuitry or interface such as an electrical cable, whereby the external power source supplies power to power circuitry of the power source 3008. As a further example, the power source 3008 may comprise a source of power in the form of a battery or battery pack which is connected to, or integrated in, power circuitry. The battery may provide backup power should the external power source fail.

Embodiments of the network node 3000 may include additional components beyond those shown in FIG. 20 for providing certain aspects of the network node's functionality, including any of the functionality described herein and/or any functionality necessary to support the subject matter described herein. For example, the network node 3000 may include user interface equipment to allow input of information into the network node 3000 and to allow output of information from the network node 3000. This may allow a user to perform diagnostic, maintenance, repair, and other administrative functions for the network node 3000.

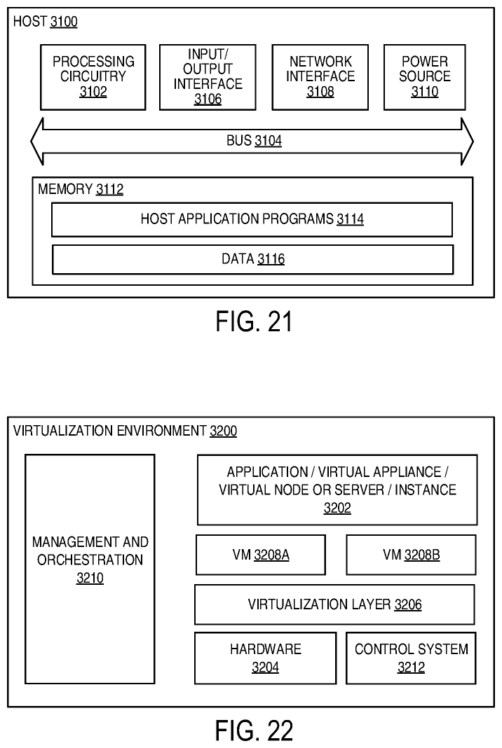

FIG. 21 is a block diagram of a host 3100, which may be an embodiment of the host 2816 of FIG. 18, in accordance with various aspects described herein. As used herein, the host 3100 may be or comprise various combinations hardware and/or software, including a standalone server, a blade server, a cloud-implemented server, a distributed server, a virtual machine, container, or processing resources in a server farm. The host 3100 may provide one or more services to one or more UEs.

The host 3100 includes processing circuitry 3102 that is operatively coupled via a bus 3104 to an input/output interface 3106, a network interface 3108, a power source 3110, and a memory 3112. Other components may be included in other embodiments. Features of these components may be substantially similar to those described with respect to the devices of previous figures, such as FIGS. 19 and 20, such that the descriptions thereof are generally applicable to the corresponding components of host 3100.

The memory 3112 may include one or more computer programs including one or more host application programs 3114 and data 3116, which may include user data, e.g., data generated by a UE for the host 3100 or data generated by the host 3100 for a UE. Embodiments of the host 3100 may utilize only a subset or all of the components shown. The host application programs 3114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 3114 may also provide for user authentication and licensing checks and may periodically report health, routes, and content availability to a central node, such as a device in or on the edge of a core network. Accordingly, the host 3100 may select and/or indicate a different host for over-the-top services for a UE. The host application programs 3114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 22 is a block diagram illustrating a virtualization environment 3200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 3200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 3202 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 3204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 3206 (also referred to as hypervisors or virtual machine monitors (VMMs)), provide VMs 3208a and 3208b (one or more of which may be generally referred to as VMs 3208), and/or perform any of the functions, features and/or benefits described in relation with some embodiments described herein. The virtualization layer 3206 may present a virtual operating platform that appears like networking hardware to the VMs 3208.

The VMs 3208 comprise virtual processing, virtual memory, virtual networking or interface and virtual storage, and may be run by a corresponding virtualization layer 3206. Different embodiments of the instance of a virtual appliance 3202 may be implemented on one or more of VMs 3208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 3208 may be a software implementation of a physical machine that runs programs as if they were executing on a physical, non-virtualized machine. Each of the VMs 3208, and that part of hardware 3204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 3208 on top of the hardware 3204 and corresponds to the application 3202.

Hardware 3204 may be implemented in a standalone network node with generic or specific components. Hardware 3204 may implement some functions via virtualization. Alternatively, hardware 3204 may be part of a larger cluster of hardware (e.g. such as in a data center or CPE) where many hardware nodes work together and are managed via management and orchestration 3210, which, among others, oversees lifecycle management of applications 3202. In some embodiments, hardware 3204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 3212 which may alternatively be used for communication between hardware nodes and radio units.

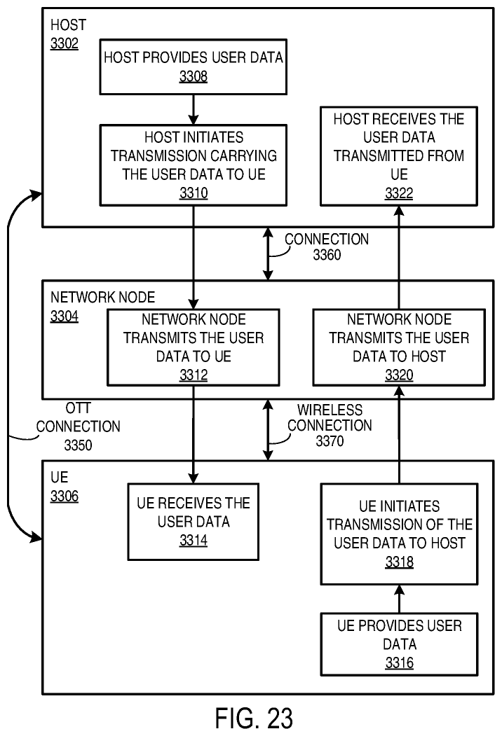

FIG. 23 shows a communication diagram of a host 3302 communicating via a network node 3304 with a UE 3306 over a partially wireless connection in accordance with some embodiments. Example implementations, in accordance with various embodiments, of the UE (such as a UE 2812a of FIG. 18 and/or UE 2900 of FIG. 19), network node (such as network node 2810a of FIG. 18 and/or network node 3000 of FIG. 20), and host (such as host 2816 of FIG. 18 and/or host 3100 of FIG. 21) discussed in the preceding paragraphs will now be described with reference to FIG. 23.

Like host 3100, embodiments of host 3302 include hardware, such as a communication interface, processing circuitry, and memory. The host 3302 also includes software, which is stored in or accessible by the host 3302 and executable by the processing circuitry. The software includes a host application that may be operable to provide a service to a remote user, such as the UE 3306 connecting via an over-the-top (OTT) connection 3350 extending between the UE 3306 and host 3302. In providing the service to the remote user, a host application may provide user data which is transmitted using the OTT connection 3350.

The network node 3304 includes hardware enabling it to communicate with the host 3302 and UE 3306. The connection 3360 may be direct or pass through a core network (like core network 2806 of FIG. 18) and/or one or more other intermediate networks, such as one or more public, private, or hosted networks. For example, an intermediate network may be a backbone network or the Internet.

The UE 3306 includes hardware and software, which is stored in or accessible by UE 3306 and executable by the UE's processing circuitry. The software includes a client application, such as a web browser or operator-specific “app” that may be operable to provide a service to a human or non-human user via UE 3306 with the support of the host 3302. In the host 3302, an executing host application may communicate with the executing client application via the OTT connection 3350 terminating at the UE 3306 and host 3302. In providing the service to the user, the UE's client application may receive request data from the host's host application and provide user data in response to the request data. The OTT connection 3350 may transfer both the request data and the user data. The UE's client application may interact with the user to generate the user data that it provides to the host application through the OTT connection 3350.

The OTT connection 3350 may extend via a connection 3360 between the host 3302 and the network node 3304 and via a wireless connection 3370 between the network node 3304 and the UE 3306 to provide the connection between the host 3302 and the UE 3306. The connection 3360 and wireless connection 3370, over which the OTT connection 3350 may be provided, have been drawn abstractly to illustrate the communication between the host 3302 and the UE 3306 via the network node 3304, without explicit reference to any intermediary devices and the precise routing of messages via these devices.

As an example of transmitting data via the OTT connection 3350, in step 3308, the host 3302 provides user data, which may be performed by executing a host application. In some embodiments, the user data is associated with a particular human user interacting with the UE 3306. In other embodiments, the user data is associated with a UE 3306 that shares data with the host 3302 without explicit human interaction. In step 3310, the host 3302 initiates a transmission carrying the user data towards the UE 3306. The host 3302 may initiate the transmission responsive to a request transmitted by the UE 3306. The request may be caused by human interaction with the UE 3306 or by operation of the client application executing on the UE 3306. The transmission may pass via the network node 3304, in accordance with the teachings of the embodiments described throughout this disclosure. Accordingly, in step 3312, the network node 3304 transmits to the UE 3306 the user data that was carried in the transmission that the host 3302 initiated, in accordance with the teachings of the embodiments described throughout this disclosure. In step 3314, the UE 3306 receives the user data carried in the transmission, which may be performed by a client application executed on the UE 3306 associated with the host application executed by the host 3302.

In some examples, the UE 3306 executes a client application which provides user data to the host 3302. The user data may be provided in reaction or response to the data received from the host 3302. Accordingly, in step 3316, the UE 3306 may provide user data, which may be performed by executing the client application. In providing the user data, the client application may further consider user input received from the user via an input/output interface of the UE 3306. Regardless of the specific manner in which the user data was provided, the UE 3306 initiates, in step 3318, transmission of the user data towards the host 3302 via the network node 3304. In step 3320, in accordance with the teachings of the embodiments described throughout this disclosure, the network node 3304 receives user data from the UE 3306 and initiates transmission of the received user data towards the host 3302. In step 3322, the host 3302 receives the user data carried in the transmission initiated by the UE 3306.

One or more of the various embodiments improve the performance of OTT services provided to the UE 3306 using the OTT connection 3350, in which the wireless connection 3370 forms the last segment. More precisely, the teachings of these embodiments may improve the resource utilization and thereby provide benefits such as more valid throughput.

In an example scenario, factory status information may be collected and analyzed by the host 3302. As another example, the host 3302 may process audio and video data which may have been retrieved from a UE for use in creating maps. As another example, the host 3302 may collect and analyze real-time data to assist in controlling vehicle congestion (e.g., controlling traffic lights). As another example, the host 3302 may store surveillance video uploaded by a UE. As another example, the host 3302 may store or control access to media content such as video, audio, VR or AR which it can broadcast, multicast or unicast to UEs. As other examples, the host 3302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 3350 between the host 3302 and UE 3306, in response to variations in the measurement results. The measurement procedure and/or the network functionality for reconfiguring the OTT connection may be implemented in software and hardware of the host 3302 and/or UE 3306. In some embodiments, sensors (not shown) may be deployed in or in association with other devices through which the OTT connection 3350 passes; the sensors may participate in the measurement procedure by supplying values of the monitored quantities exemplified above, or supplying values of other physical quantities from which software may compute or estimate the monitored quantities. The reconfiguring of the OTT connection 3350 may include message format, retransmission settings, preferred routing etc.; the reconfiguring need not directly alter the operation of the network node 3304. Such procedures and functionalities may be known and practiced in the art. In certain embodiments, measurements may involve proprietary UE signaling that facilitates measurements of throughput, propagation times, latency and the like, by the host 3302. The measurements may be implemented in that software causes messages to be transmitted, in particular empty or ‘dummy’ messages, using the OTT connection 3350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one skilled in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements. It should be noted that two blocks shown in succession in the above figures may, in fact, be executed substantially concurrently, or the blocks may sometimes be executed in the reverse order, depending upon the functionality involved.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1. A method performed by a first network function, NF, comprising:
receiving, from a second NF, control information for controlling non-access stratum, NAS, traffic that is to be processed by the first NF, wherein the control information instructs the first NF to perform a predetermined action on the NAS traffic when the NAS traffic satisfies a predetermined condition; and
sending, to the second NF, a response to the control information.

2. The method according to claim 1, further comprising:
when the NAS traffic satisfies the predetermined condition, performing the predetermined action on the NAS traffic according to the control information.

3. The method according to claim 1, further comprising:
sending, to the second NF, assistance information usable for determining the control information.

4. The method according to claim 3, wherein the assistance information comprises one or more of:
at least one key performance indicator, KPI, related to the NAS traffic;
at least one counter for checking health status of the first network function;
a log of events occurring at the first network function; and
the NAS traffic processed by the first network function.

5. The method according to claim 1, wherein the predetermined action is one of:
accepting the NAS traffic;
rejecting the NAS traffic; and
ignoring the NAS traffic.

6. The method according to claim 1, wherein the control information comprises:
a first identifier, ID, identifying a target NF for which the control is applied to the NAS traffic;
a first indicator indicating at least one rule for defining the predetermined condition; and
a second indicator indicating the predetermined action.

7. The method according to claim 6, wherein the control information further comprises one or more of:
a second ID identifying the control information; and
a third indicator indicating a validity time of the control information.

8. The method according to claim 6, wherein the at least one rule comprises one or more of:
a first rule indicating that the control should be applied to the NAS traffic of any terminal device;
a second rule indicating that the control should be applied to the NAS traffic of a specific terminal device;
a third rule indicating that the control should be applied in one or more specific events;
a fourth rule indicating that the control should be applied to the NAS traffic related to a specific data network name, DNN;
a fifth rule indicating that the control should be applied to the NAS traffic related to a specific protocol data unit, PDU, session;
a sixth rule indicating that the control should be applied to the NAS traffic of one or more terminal devices at a specific location; and
a seventh rule indicating that the control should be applied to the NAS traffic having a specific traffic pattern.

9. The method according to claim 8, wherein the NAS traffic having the specific traffic pattern is an NAS traffic whose payload is an Internet protocol, IP, based packet having a specific feature in content.

10. The method according to claim 9, wherein the IP based packet comprises one or more of:
an Internet control message protocol, ICMP, packet;
a transmission control protocol, TCP, packet;
a user datagram protocol, UDP, packet; and
a stream control transmission protocol, SCTP, packet.

11. The method according to claim 1, wherein the response indicates that the control applied to the NAS traffic is initiated; or
wherein the response indicates why the control applied to the NAS traffic cannot be initiated.

12. The method according to claim 1, wherein the first NF is one of:
an access and mobility management function, AMF;
a session management function, SMF;
a network exposure function, NEF; and
a short message service function, SMSF.

13. The method according to claim 1, wherein the second NF is one of:
a network data analytics function, NWDAF; and
an operation and maintenance, O&M.

14. The method according to claim 6, wherein the target NF is one of:
an SMF;
an NEF;
a unified data management, UDM;
a policy control function, PCF; and
an application function, AF.

15. A method performed by a second network function, NF, comprising:
sending, to a first NF, control information for controlling non-access stratum, NAS, traffic that is to be processed by the first NF, wherein the control information instructs the first NF to perform a predetermined action on the NAS traffic when the NAS traffic satisfies a predetermined condition; and
receiving, from the first NF, a response to the control information.

16. The method according to claim 15, further comprising:
receiving, from the first NF or another NF related to the first NF, assistance information usable for determining the control information; and
determining the control information based on the assistance information.

17. The method according to claim 16, wherein the assistance information comprises one or more of:
at least one key performance indicator, KPI, related to the NAS traffic;
at least one counter for checking health status of the first network function;
a log of events occurring at the first network function; and
the NAS traffic processed by the first network function.

18. The method according to claim 15, wherein the predetermined action is one of:
accepting the NAS traffic;
rejecting the NAS traffic; and
ignoring the NAS traffic.

19. The method according to claim 15, wherein the control information comprises:
a first identifier, ID, identifying a target NF for which the control is applied to the NAS traffic;
a first indicator indicating at least one rule for defining the predetermined condition; and
a second indicator indicating the predetermined action.

20-27. (canceled)

28. An apparatus implementing a first network function, NF, comprising:
at least one processor; and
at least one memory, the at least one memory containing instructions executable by the at least one processor, whereby the apparatus is operative to:
receive, from a second NF, control information for controlling non-access stratum, NAS, traffic that is to be processed by the first NF, wherein the control information instructs the first NF to perform a predetermined action on the NAS traffic when the NAS traffic satisfies a predetermined condition; and
send, to the second NF, a response to the control information.

29-32. (canceled)
